(19) United States
(12) Patent Application Publication
(10) Pub. No.: US 2026/0291323 A1
(43) Pub. Date: Sep. 24, 2026

(54) ROTATING ELECTRIC MACHINE SYSTEM

(71) Applicant: HONDA MOTOR CO., LTD., Tokyo (JP)

(72) Inventor: Tsubasa Nakatomi, Wako-shi (JP)

(21) Appl. No.: 19/566,180

(22) Filed: Mar. 13, 2026

(30) Foreign Application Priority Data
Mar. 18, 2025 (JP) 2025-043492

(51) Int. Cl. H02K 5/20; H02K 9/19

(52) U.S. Cl. CPC H02K 5/203; H02K 9/19

(57) ABSTRACT

In the interior of a rotating electric machine housing of a rotating electric machine system, there are formed a plurality of cooling medium passages disposed at intervals in a circumferential direction of a rotating electric machine so as to surround a stator, a cooling medium supply path extending along the circumferential direction, and configured to supply a cooling medium to a plurality of cooling medium passages, and a cooling medium discharge path extending along the circumferential direction, and configured to discharge the cooling medium from the plurality of cooling medium passages. The cross-sectional area of the cooling medium supply path gradually decreases from an inlet portion to which an inlet flow path is connected toward an opposite portion on the opposite side of the inlet flow path.

### CROSS-REFERENCE TO RELATED APPLICATIONS

This application is based upon and claims the benefit of priority from Japanese Patent Application No. 2025-043492 filed on March 18, 2025, the contents of which are incorporated herein by reference.

### BACKGROUND OF THE INVENTION

### Field of the Invention

The present disclosure relates to a rotating electric machine system.

### Description of the Related Art

A configuration in which a cooling medium is caused to flow through a water jacket formed inside a rotating electric machine housing in order to cool a stator is known. JP 2023-070064 A discloses a configuration in which a plurality of cooling medium passages are formed in a rotating electric machine housing at intervals in a circumferential direction. The cooling medium passages are supplied with cooling medium from an annular supply path.

### SUMMARY OF THE INVENTION

It is desired to equalize the flow velocity of the cooling medium in the plurality of cooling medium passages and efficiently cool the stator.

An object of the present disclosure is to meet the aforementioned need.

An aspect of the present disclosure is characterized by a rotating electric machine system provided with a rotating electric machine including a rotor and a stator, and a rotating electric machine housing configured to accommodate the rotating electric machine, wherein in an interior of the rotating electric machine housing, there are formed a plurality of cooling medium passages arranged at intervals in a circumferential direction of the rotating electric machine so as to surround the stator, a cooling medium supply path extending along the circumferential direction, connected to upstream ends of the plurality of cooling medium passages, and configured to supply a cooling medium to the plurality of cooling medium passages, and a cooling medium discharge path extending along the circumferential direction, connected to downstream ends of the plurality of cooling medium passages, and configured to discharge the cooling medium from the plurality of cooling medium passages, and wherein an inlet flow path is connected to the cooling medium supply path, and the cooling medium supply path includes an inlet portion to which the inlet flow path is connected and an opposite portion on an opposite side to the inlet flow path, and a cross-sectional area of the cooling medium supply path gradually decreases from the inlet portion toward the opposite portion.

In accordance with the rotating electric machine system according to the present invention, the pressure loss in the cooling medium supply path on the side closer to the inlet flow path is reduced, and the pressure loss on the side closer to the opposite portion is increased, so that the flow velocity of the cooling medium in the plurality of cooling medium passages can be equalized. In accordance with this feature, the stator can be sufficiently cooled.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a combined motive power system;

FIG. 2 is a schematic cross-sectional view of a rotating electric machine system;

FIG. 3 is a perspective view illustrating flow path shapes of a cooling medium supply path, a cooling medium passage, and a cooling medium discharge path;

FIG. 4 is a graph illustrating a relationship between a phase and a cross-sectional area in a cooling medium supply path; and

FIG. 5 is a cross-sectional view illustrating an opening shape of the cooling medium passage.

### DETAILED DESCRIPTION OF THE INVENTION

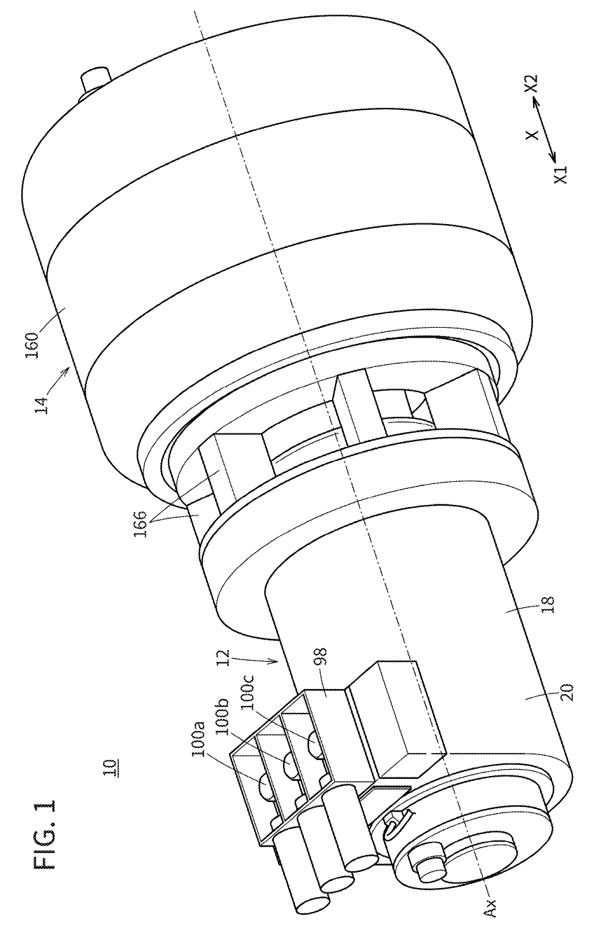

A combined motive power system 10 shown in FIG. 1 is equipped with a rotating electric machine system 12 according to the present embodiment, and a gas turbine engine 14. An axis Ax of the rotating electric machine system 12, and an axis Ax of the gas turbine engine 14 coincide with each other. Stated otherwise, the rotating electric machine system 12 and the gas turbine engine 14 are arranged in series on the same axis Ax.

The combined motive power system 10 is used, for example, as a power source for providing propulsion in a flying object, a ship, an automobile, or the like. Suitable specific examples of the flying object include drones or multicopters. The combined motive power system 10, when mounted on a flying object, is used as a power drive source for rotating, for example, a prop, a ducted fan, or the like. The combined motive power system 10, when mounted on a ship, is used as a screw rotational force generating device. The combined motive power system 10, when mounted on an automobile, is used as a power drive source for rotating a motor.

The combined motive power system 10 can also be used as an auxiliary power source in an aircraft, a ship, a building, or the like. Apart therefrom, it is also possible to utilize the combined motive power system 10 as gas turbine power generation equipment. The gas turbine engine 14 is an internal combustion engine.

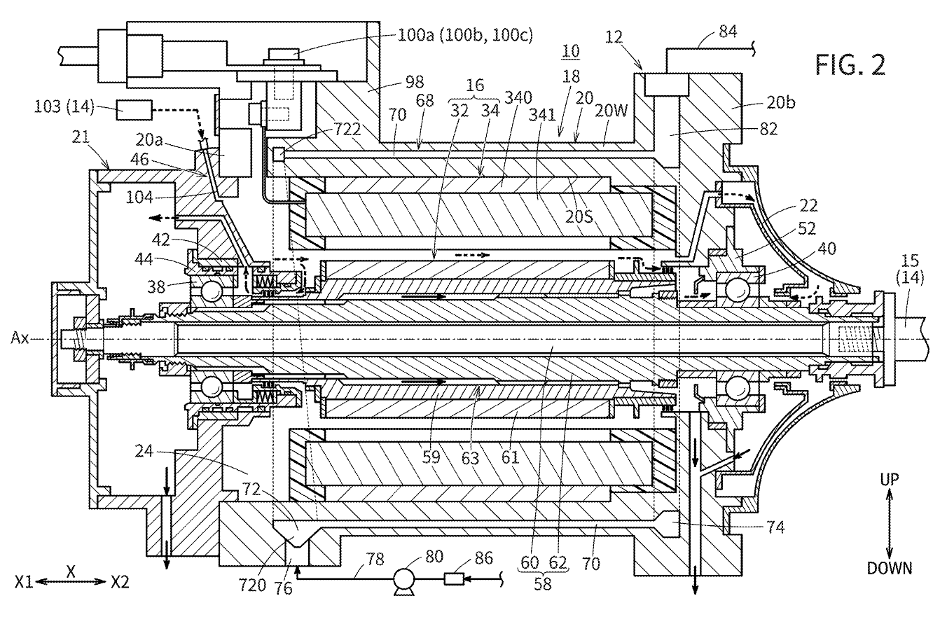

In the following description, the respective terms "lower" and "upper" refer specifically to the lower and the upper directions shown in FIG. 2.

As shown in FIG. 2, the rotating electric machine system 12 includes a rotating electric machine 16 and a rotating electric machine housing 18. In the present embodiment, the rotating electric machine 16 is an electrical power generator. The rotating electric machine 16 includes a rotor 32 and a stator 34.

The rotating electric machine housing 18 accommodates the rotating electric machine 16. The rotating electric machine housing 18 includes a main housing 20, and a sub-housing 21. The main housing 20 and the sub-housing 21 are made of, for example, an aluminum alloy. The main housing 20 is manufactured by, for example, metal additive manufacturing (Metal AM). The main housing 20 has a substantially cylindrical shape both ends of which are open. The main housing 20 includes an accommodation chamber 24 that serves to accommodate the rotating electric machine 16.

The sub-housing 21 is connected to a first housing end 20a, which is an end part on a side in the X1 direction of the main housing 20, and thereby closes an opening of the first housing end 20a. A bearing cover 22 is connected to a second housing end 20b, which is an end part on a side in the X2 direction of the main housing 20, and thereby closes an opening of the second housing end 20b.

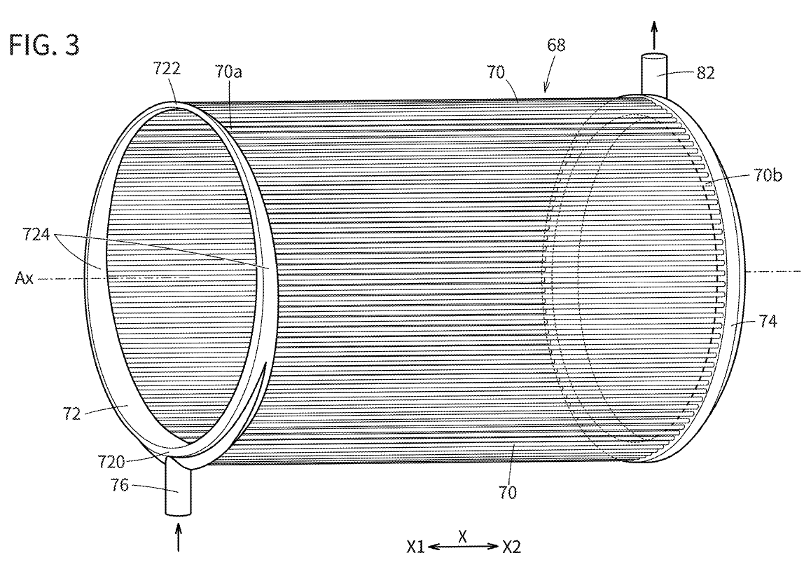

A cooling jacket 68 is formed in the interior of a circumferential wall portion 20W of the main housing 20. A cooling medium such as cooling water flows through the cooling jacket 68. The cooling jacket 68 has a plurality of cooling medium passages 70. Each of the cooling medium passages 70 extends along the axis Ax. The plurality of cooling medium passages 70 are arranged at intervals in the circumferential direction of the rotating electric machine 16 so as to surround the stator 34. As shown in FIG. 3, in the present embodiment, the plurality of cooling medium passages 70 are arranged at equal intervals in the circumferential direction.

As shown in FIG. 2, a cooling medium supply path 72 and a cooling medium discharge path 74 are further provided inside the circumferential wall portion 20W of the main housing 20. An inlet flow path 76 is connected to the cooling medium supply path 72. A supply line 78 is connected to the inlet flow path 76. The supply line 78 is provided with a pump 80. As shown in FIG. 3, the cooling medium supplby path 72 extends along the circumferential direction. Specifically, the cooling medium supply path 72 has an annular shape. The cooling medium supply path 72 is connected to upstream ends 70a of the plurality of cooling medium passages 70, and supplies the cooling medium to the plurality of cooling medium passages 70.

The cooling medium supply path 72 includes an inlet portion 720, an opposite portion 722, and middle portions 724. The inlet portion 720 is a portion of the cooling medium supply path 72 to which the inlet flow path 76 is connected. The opposite portion 722 is a portion of the cooling medium supply path 72 on the opposite side of the inlet portion 720 with respect to the axis Ax. Each of the middle portions 724 is a portion located in the middle between the inlet portion 720 and the opposite portion 722 in the circumferential direction. Therefore, the cooling medium supply path 72 has two of the middle portions 724. The cooling medium supply path 72 has a first region and a second region between the inlet portion 720 and the opposite portion 722. The first region is a range from the inlet portion 720 to the middle portions 724, and the second region is a range from the middle portions 724 to the opposite portion 722.

The cross-sectional shape of the cooling medium supply path 72 is substantially triangular at the inlet portion 720. The cross-sectional shape of the cooling medium supply path 72 changes from a substantially triangular shape to a substantially rectangular shape from the inlet portion 720 toward the middle portions 724. The cross-sectional shape of the cooling medium supply path 72 may be another polygonal shape from the inlet portion 720 to the middle portions 724, or may be a circular shape, an elliptical shape, or the like.

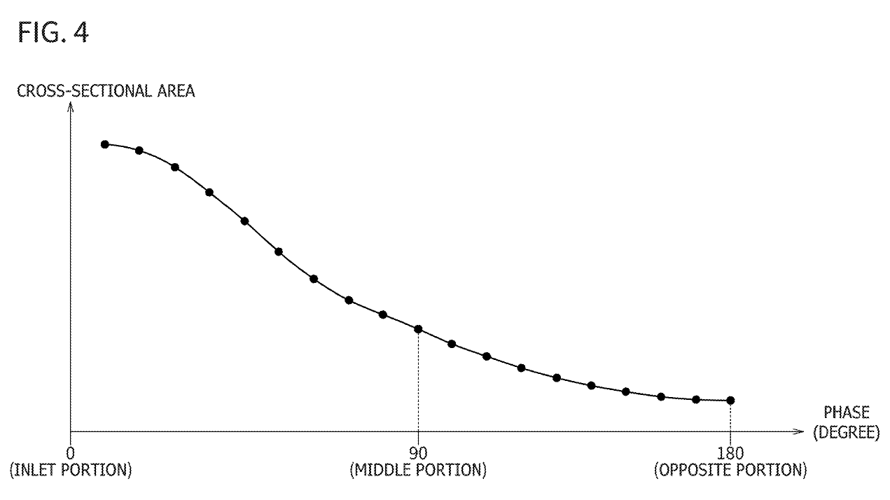

As shown in FIG. 4, the cross-sectional area of the cooling medium supply path 72 gradually decreases from the inlet portion 720 toward the opposite portion 722. Therefore, in the cooling medium discharge path 74, the cross-sectional area of the inlet portion 720 is largest, and the cross-sectional area of the opposite portion 722 is smallest. The cross-sectional area of the inlet portion 720 of the cooling medium supply path 72 is 5 to 15 times the cross-sectional area of the opposite portion 722. Preferably, the cross-sectional area of the inlet portion 720 is 8 to 10 times the cross-sectional area of the opposite portion 722. If the cross-sectional area of the inlet portion 720 is smaller than five times the cross-sectional area of the opposite portion 722, the flow rates of the plurality of cooling medium passages 70 are not uniform. On the other hand, when the flow rate is larger than 15 times, a large flow rate of the cooling medium is required, and it is necessary to increase the load of the pump or the like or to increase the size of the auxiliary device. The rate of change in the cross-sectional area of the cooling medium supply path 72 from the inlet portion 720 to the middle portions 724 is greater than the rate of change in the cross-sectional area from the middle portions 724 to the opposite portion 722. As shown in FIG. 2, the length of the inlet portion 720 in the axial direction (X direction) is longer than that of the opposite portion 722.

As shown in FIG. 3, the cooling medium discharge path 74 extends along the circumferential direction. Specifically, the cooling medium discharge path 74 has an annular shape. The cooling medium discharge path 74 is connected to downstream ends 70b of the plurality of cooling medium passages 70, and discharges the cooling medium from the plurality of cooling medium passages 70. The cooling medium discharge path 74 has a constant cross-sectional area along the circumferential direction. As shown in FIG. 2, an outlet flow path 82 is connected to the cooling medium discharge path 74. A discharge line 84 is connected to the outlet flow path 82.

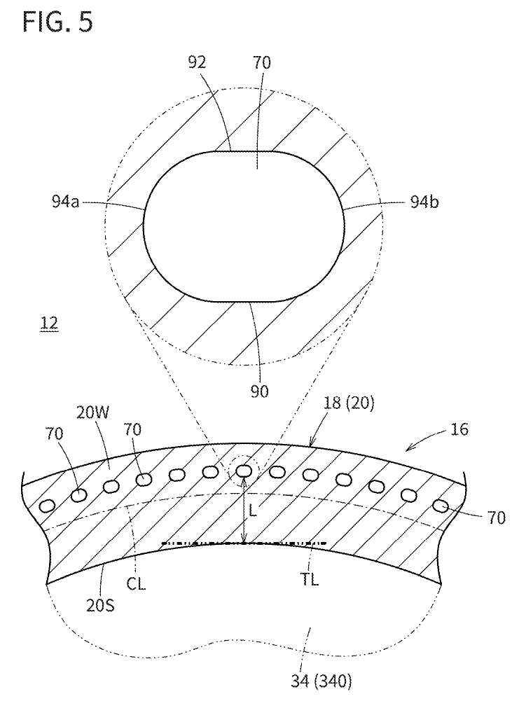

As shown in FIG. 5, in a cross section perpendicular to the axis Ax of the rotating electric machine 16 (see FIG. 2), the opening shape of each of the plurality of cooling medium passages 70 includes an inner side portion 90, an outer side portion 92, and a pair of arc portions 94a and 94b. The inner side portion 90 constitutes the inner side of the opening shape in the radial direction of the rotating electric machine 16. The inner side portion 90 is a straight portion parallel to a tangent line TL of the outer circumferential surface of the stator 34 in a line drawn from the inner side portion 90 toward the axis Ax (FIG. 3). The length of the inner side portion 90 can be set to 1/3 to 1/2 of the length between the inner side portion 90 and the outer side portion 92, and is, for example, 0.1 mm to 1.2 mm, and preferably 0.3 mm to 0.8 mm.

The outer side portion 92 constitutes the outer side of the opening shape in the radial direction. The outer side portion 92 is a straight portion parallel to the inner side portion 90. The length of the outer side portion 92 is the same as the length of the inner side portion 90. The pair of arc portions 94a and 94b connect the inner side portion 90 and the outer side portion 92 in an arc shape. To be specific, one arc portion 94a connects one end of the inner side portion 90 and one end of the outer side portion 92. The other arc portion 94b connects another end of the inner side portion 90 and another end of the outer side portion 92. The opening shape of the cooling medium passages 70 configured as described above has a major axis along the circumferential direction of the rotating electric machine 16 and a minor axis along the radial direction of the rotating electric machine 16.

The plurality of cooling medium passages 70 are provided outside the central position in the radial direction of the circumferential wall portion 20W of the rotating electric machine housing 18 (main housing 20). A circular center line CL indicating a central position of the circumferential wall portion 20W in the radial direction is indicated by an imaginary line. The plurality of cooling medium passages 70 are formed between the center line CL and the outer circumferential surface of the circumferential wall portion 20W. In the case of the above-described example, a radial length L between one of the cooling medium passages 70 and an inner circumferential surface 20S of the circumferential wall portion 20W is, for example, 5 mm to 12 mm, and preferably 7 mm to 10 mm.

As shown in FIG. 2, the rotor 32 is rotatably supported by the rotating electric machine housing 18 via a first bearing 38 and a second bearing 40. A hollow cylindrically shaped holder spacer 42 and a hollow cylindrically shaped first bearing holder 44 are inserted into the inner circumferential part of the sub-housing 21. The first bearing 38 is disposed on an inner side of the first bearing holder 44. A lubricating oil is supplied to the first bearing 38. An annular shaped second bearing holder 52 is mounted on the second housing end 20b (an end part on a side in the X2 direction) of the main housing 20. The second bearing 40 is retained on an inner circumferential part of the second bearing holder 52. A lubricating oil is supplied to the second bearing 40.

The rotor 32 includes a rotating shaft 58, a sleeve 59, and permanent magnets 61. The sleeve 59 surrounds the rotating shaft 58, and the permanent magnets 61 surround the sleeve 59. A rotor internal flow path 63 is formed in the rotor 32. According to the present embodiment, the lubricating oil flows as a liquid cooling medium through the rotor internal flow path 63. The lubricating oil flows in the X2 direction through the rotor internal flow path 63.

The rotating shaft 58, together with being supported to be capable of rotating by the sub-housing 21 via the first bearing 38, is supported to be capable of rotating by the main housing 20 via the second bearing 40. The rotating shaft 58 includes an inner shaft 60, and an outer shaft 62. The rotating shaft 58 is inserted into the sleeve 59. The sleeve 59 surrounds the rotating shaft 58. The sleeve 59 is fixed, for example, by shrink fitting, to an outer surface of the rotating shaft 58. The permanent magnets 61 are retained in the sleeve 59.

The stator 34 includes a stator core 340, and the plurality of individual electromagnetic coils 341. The stator core 340 is a cylindrical member. The outer circumferential surface of the stator core 340 is fixed to the inner circumferential surface of the main housing 20 (the inner circumferential surface 20S of the circumferential wall portion 20W) by, for example, shrink fitting. The stator core 340 is made of a steel material. The stator core 340 is constituted, for example, by laminating a plurality of ring-shaped electromagnetic steel plates in the axial direction. A plurality of slots are formed in the stator core 340. Teeth portions are formed between adjacent ones of the slots.

The plurality of electromagnetic coils 341 include a U-phase coil, a V-phase coil, and a W-phase coil. Therefore, in the case that the rotating electric machine 16 is a generator, the rotating electric machine 16 is a so-called three-phase electrical power source. Each of the plurality of electromagnetic coils 341 is constituted by winding a conductive wire around the teeth of the stator core 340.

As shown in FIG. 1, a terminal casing 98 is integrally disposed on an upper surface on a side in the X1 direction of the main housing 20. As shown in FIG. 2, a U-phase terminal 100a, a V-phase terminal 100b, and a W-phase terminal 100c are accommodated inside the terminal casing 98. The U-phase terminal 100a, the V-phase terminal 100b, and the W-phase terminal 100c are electrically connected respectively to the U-phase coil, the V-phase coil, and the W-phase coil of the stator 34.

A sealing air flow path structure 46 is further provided in the rotating electric machine system 12. The air is supplied from a gas supply device 103. Moreover, the air that is supplied to the rotating electric machine housing 18 forms an air curtain in order to prevent the lubricating oil from entering the accommodation chamber 24.

Next, a description will be given concerning the gas turbine engine 14 shown in FIG. 1. Moreover, it should be noted that the configuration of the gas turbine engine 14, for example, is similar to the configuration shown in FIG. 7 of JP 2023-106078 A. Therefore, the description of the gas turbine engine 14 will be kept brief.

The gas turbine engine 14 includes an engine housing 160. The engine housing 160 is connected to the rotating electric machine housing 18. The engine housing 160 includes a plurality of leg members 166. An air intake space is formed between the leg members 166.

As shown in FIG. 2, the gas turbine engine 14 is equipped with an output shaft 15. A non-illustrated compressor wheel and a non-illustrated turbine wheel are mounted radially outward of the output shaft 15. The output shaft 15 is coupled to the rotating shaft 58. The compressor wheel and the turbine wheel are capable of rotating integrally together with the rotating shaft 58 and the output shaft 15.

The gas turbine engine 14 may be the gas supply device 103 that supplies the air to the sealing air flow path structure 46. In this case, a portion of the air that is generated by the rotation of the compressor wheel is extracted, and is supplied to a gas supply path 104 that is disposed in the sub-housing 21. Moreover, the gas supply device 103 may be another compressor that compresses the atmosphere and supplies the same to the gas supply path 104. The cooling gas that is supplied to the gas supply path 104 may be a gas that is supplied from an oxygen cylinder, a nitrogen cylinder, or the like.

The combined motive power system 10 that is constituted as described above operates in the following manner.

First, by driving the rotating electric machine 16, the gas turbine engine 14 is started. When the gas turbine engine 14 starts, the rotor 32 of the rotating electric machine 16 rotates due to the rotational driving force of the output shaft 15 of the gas turbine engine 14, and electricity is generated in the rotating electric machine 16. In accordance with this feature, the combined motive power system 10 is placed in operation.

During operation of the combined motive power system 10, the pump 80 is driven to supply a cooling medium to the inlet flow path 76 via a supply line 78. In FIG. 3, the cooling medium flows into the annular cooling medium supply path 72, and is divided into two flows in opposite directions in the circumferential direction at the inlet portion 720. The cooling medium flows from the inlet portion 720 to the opposite portion 722 via the middle portions 724. The cooling medium is divided into the plurality of cooling medium passages 70 by the cooling medium supply path 72. The cooling medium flows into the plurality of cooling medium passages 70 and flows in the X2 direction. The cooling medium cools the stator 34 (FIG. 2) while flowing through the plurality of cooling medium passages 70. The cooling medium flows from the plurality of cooling medium passages 70 into the cooling medium discharge path 74, and merges in the cooling medium discharge path 74. In FIG. 2, the cooling medium flows from the cooling medium discharge path 74 into the discharge line 84 via the outlet flow path 82. The cooling medium is cooled by a heat exchanger 86 provided in the discharge line 84, and then supplied to the inlet flow path 76 again by the pump 80.

Meanwhile, air is supplied from the gas supply device 103 to the rotating electric machine housing 18. In accordance with this feature, sealing can be performed by the air curtain. The lubricating oil is supplied to the first bearing 38 and the second bearing 40. The lubricating oil is supplied to the rotor internal flow path 63, and the permanent magnets 61 is cooled by the lubricating oil flowing through the rotor internal flow path 63.

According to the present embodiment, the following effects are obtained.

As shown in FIG. 3, the cross-sectional area of the cooling medium supply path 72 gradually decreases from the inlet portion 720 to which the inlet flow path 76 is connected toward the opposite portion 722 on the opposite side of the inlet flow path 76. In accordance with such a configuration, the pressure loss in the cooling medium supply path 72 on the side closer to the inlet flow path 76 is reduced, and the pressure loss on the side closer to the opposite portion 722 is increased, so that the flow velocity of the cooling medium in the plurality of cooling medium passages 70 can be equalized. In accordance with this feature, the stator 34 (see FIG. 2) can be sufficiently cooled. The flow velocity of the cooling medium in the plurality of cooling medium passages 70 is not necessarily equalized substantially completely. When the minimum flow velocity in the plurality of cooling medium passages 70 is, for example, 75 % or more of the average flow velocity value of the plurality of cooling medium passages 70, the flow velocity is equalized.

Unlike the present embodiment, when the cross-sectional area of the cooling medium supply path 72 is constant from the inlet portion 720 to the opposite portion 722, the flow velocity at the inlet portion 720 is decreased, and the flow velocity at the opposite portion 722 is increased. Therefore, when the cross-sectional area of the cooling medium supply path 72 is constant in the circumferential direction, a large variation occurs in the flow velocity of the cooling medium flowing through the plurality of cooling medium passages 70. The case where the variation in the flow velocity is large is a case where the minimum flow velocity in the plurality of cooling medium passages 70 is, for example, 60 % or less of the average flow velocity value of the plurality of cooling medium passages 70.

The cross-sectional area of the inlet portion 720 of the cooling medium supply path 72 is 5 to 15 times the cross-sectional area of the opposite portion 722. In accordance with such a configuration, the flow velocity of the cooling medium in the plurality of cooling medium passages 70 can be effectively equalized.

The rate of change in the cross-sectional area of the first region of the cooling medium supply path 72 is greater than the rate of change in the cross-sectional area of the second region. In accordance with such a configuration, the flow velocity of the cooling medium in the plurality of cooling medium passages 70 can be effectively equalized.

The rate of change in the cross-sectional area of the cooling medium supply path 72 from the inlet portion 720 to the middle portions 724 is greater than the rate of change in the cross-sectional area from the middle portions 724 to the opposite portion 722. In accordance with such a configuration, the flow velocity of the cooling medium in the plurality of cooling medium passages 70 can be effectively equalized.

The plurality of cooling medium passages 70 are arranged at equal intervals in the circumferential direction. In accordance with such a configuration, the stator 34 (FIG. 2) can be efficiently cooled.

The cooling medium discharge path 74 has a constant cross-sectional area along the circumferential direction. In accordance with such a configuration, since the cross-sectional area of only the cooling medium supply path 72 is changed, the flow velocity of the cooling medium in the plurality of cooling medium passages 70 can be effectively equalized while suppressing the complication of the flow path structure.

As shown in FIG. 5, the opening shape of each of the plurality of cooling medium passages 70 has the inner side portion 90 that constitutes the inner side of the opening shape in the radial direction of the rotating electric machine 16. The inner side portion 90 is parallel to the tangential direction of the outer circumferential surface of the stator 34. In accordance with such a configuration, it is possible to reduce the concentration of stress on the cooling medium passages 70 due to the difference in the coefficient of linear expansion between the stator 34 and the rotating electric machine housing 18. More details are as follows.

As described above, in the present embodiment, the stator 34 is fixed to the inner circumferential surface of the main housing 20 by shrink fitting. In the case that the stator core 340 is made of a steel material and the main housing 20 is made of an aluminum alloy, a difference in the coefficient of linear expansion between the stator core 340 and the main housing 20 is large, and thus a tensile load is generated in the main housing 20 due to shrink fitting of the stator 34. This tensile load is maximized particularly when the rotating electric machine system 12 is stored at a low temperature. In the present embodiment, the inner side portion 90 of the cooling medium passage 70, which is likely to be affected by the tensile load, is formed parallel to the tangential direction of the outer circumferential surface of the stator 34. Since the inner side portion 90 is linear, the stress concentration on the cooling medium passage 70 is reduced, and the deformation of the cooling medium supply path 72 is suppressed. Therefore, the durability of the rotating electric machine housing 18 can be improved.

The opening shape of the cooling medium passage 70 includes the outer side portion 92 that constitutes the outer side of the opening shape in the radial direction and is parallel to the inner side portion 90, and a pair of arc portions 94a and 94b that connect the inner side portion 90 and the outer side portion 92. In accordance with such a configuration, the concentration of stress on the cooling medium passage 70 can be reduced with a simple shape.

The plurality of cooling medium passages 70 are provided outside a central position (center line CL) in the radial direction of the circumferential wall portion 20W of the rotating electric machine housing 18. In accordance with such a configuration, the thickness from the inner circumferential surface of the rotating electric machine housing 18 to the plurality of cooling medium passages 70 is appropriately secured, and thus it is possible to more effectively alleviate the stress concentration on the cooling medium passages 70.

The following supplementary notes are further disclosed in relation to the above embodiment.

### Supplementary Note 1

The rotating electric machine system (12) according to the present disclosure is provided with the rotating electric machine (16) including the rotor (32) and the stator (34), and the rotating electric machine housing (18) configured to accommodate the rotating electric machine, wherein in the interior of the rotating electric machine housing, there are formed the plurality of cooling medium passages (70) arranged at intervals in the circumferential direction of the rotating electric machine so as to surround the stator, the cooling medium supply path (72) extending along the circumferential direction, connected to the upstream ends (70a) of the plurality of cooling medium passages, and configured to supply the cooling medium to the plurality of cooling medium passages, and the cooling medium discharge path (74) extending along the circumferential direction, connected to the downstream ends (70b) of the plurality of cooling medium passages, and configured to discharge the cooling medium from the plurality of cooling medium passages, and wherein the inlet flow path (76) is connected to the cooling medium supply path, and the cooling medium supply path includes the inlet portion (720) to which the inlet flow path is connected and the opposite portion (722) on the opposite side to the inlet flow path, and the cross-sectional area of the cooling medium supply path gradually decreases from the inlet portion toward the opposite portion. In accordance with such a configuration, the pressure loss in the cooling medium supply path on the side closer to the inlet flow path is reduced, and the pressure loss on the side closer to the opposite portion is increased, so that the flow velocity of the cooling medium in the plurality of cooling medium passages can be equalized. In accordance with this feature, the stator can be sufficiently cooled.

### Supplementary Note 2

In the rotating electric machine system according to Supplementary Note 1, in the cooling medium supply path, the cross-sectional area of the inlet portion may be 5 to 15 times the cross-sectional area of the opposite portion. In accordance with such a configuration, the flow velocity of the cooling medium in the plurality of cooling medium passages can be effectively equalized.

### Supplementary Note 3

In the rotating electric machine system according to Supplementary Note 1 or 2, the cooling medium supply path may include the first region and the second region between the inlet portion and the opposite portion in the circumferential direction, and the rate of change in the cross-sectional area in the first region may be larger than the rate of change in a cross-sectional area in the second region. In accordance with such a configuration, the flow velocity of the cooling medium in the plurality of cooling medium passages can be effectively equalized.

### Supplementary Note 4

In the rotating electric machine system according to Supplementary Note 3, the cooling medium supply path may include the middle portion (724) located in the middle between the inlet portion and the opposite portion in the circumferential direction, and the first region may range from the inlet portion to the middle portion of the cooling medium supply path, and the second region may range from the middle portion to the opposite portion of the cooling medium supply path. In accordance with such a configuration, the flow velocity of the cooling medium in the plurality of cooling medium passages can be effectively equalized.

### Supplementary Note 5

In the rotating electric machine system according to any one of Supplementary Notes 1 to 4, the plurality of cooling medium passages may be arranged at equal intervals in the circumferential direction. In accordance with such a configuration, the stator can be efficiently cooled.

### Supplementary Note 6

In the rotating electric machine system according to any one of Supplementary Notes 1 to 5, the cooling medium discharge path may have the constant cross-sectional area along the circumferential direction. In accordance with such a configuration, since the cross-sectional area of only the cooling medium supply path is changed, the flow velocity of the cooling medium in the plurality of cooling medium passages can be effectively equalized while suppressing the complication of the flow path structure.

### Supplementary Note 7

In the rotating electric machine system according to any one of Supplementary Notes 1 to 6, in the cross section perpendicular to the axis (Ax) of the rotating electric machine, the opening shape of each of the plurality of cooling medium passages may include the inner side portion (90) constituting the inner side of the opening shape in the radial direction of the rotating electric machine, and the inner side portion may be parallel to the tangential direction of the outer circumferential surface of the stator. In accordance with such a configuration, it is possible to reduce the concentration of stress on the cooling medium passages due to the difference in the coefficient of linear expansion between the stator and the rotating electric machine housing, and to suppress the deformation of the cooling medium passages. Therefore, the durability of the rotating electric machine housing can be improved.

### Supplementary Note 8

In the rotating electric machine system according to Supplementary Note 7, the opening shape may include the outer side portion (92) that constitutes the outer side of the opening shape in the radial direction and is parallel to the inner side portion, and the pair of arc portions (94a, 94b) that connect the inner side portion and the outer side portion. In accordance with such a configuration, the concentration of stress on the cooling medium passages can be reduced with a simple shape.

### Supplementary Note 9

In the rotating electric machine system according to Supplementary Note 7 or 8, the plurality of cooling medium passages may be provided outside the central position in the radial direction of the circumferential wall portion of the rotating electric machine housing. In accordance with such a configuration, the thickness from the inner circumferential surface of the rotating electric machine housing to the plurality of cooling medium passages is secured, and thus it is possible to more effectively alleviate the stress concentration on the cooling medium passages.

### Supplementary Note 10

In the rotating electric machine system according to any one of Supplementary Notes 7 to 9, the outer circumferential surface of the stator is fixed to the inner circumferential surface of the rotating electric machine housing.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the purpose and gist of the present disclosure as derived from the contents described in the claims and their equivalents. Further, these embodiments can also be implemented in combination. For example, in the above-described embodiments, the order of the operations and the order of the processes are shown merely as examples, and the present invention is not necessarily limited to these examples. Further, the same also applies to cases in which numerical values or mathematical expressions are used in the description of the aforementioned embodiments.

What is claimed is:

1. A rotating electric machine system provided with a rotating electric machine including a rotor and a stator, and a rotating electric machine housing configured to accommodate the rotating electric machine,
wherein in an interior of the rotating electric machine housing, there are formed:
a plurality of cooling medium passages arranged at intervals in a circumferential direction of the rotating electric machine so as to surround the stator;
a cooling medium supply path extending along the circumferential direction, connected to upstream ends of the plurality of cooling medium passages, and configured to supply a cooling medium to the plurality of cooling medium passages; and
a cooling medium discharge path extending along the circumferential direction, connected to downstream ends of the plurality of cooling medium passages, and configured to discharge the cooling medium from the plurality of cooling medium passages, and
wherein an inlet flow path is connected to the cooling medium supply path, and
the cooling medium supply path includes an inlet portion to which the inlet flow path is connected and an opposite portion on an opposite side to the inlet flow path, and a cross-sectional area of the cooling medium supply path gradually decreases from the inlet portion toward the opposite portion.

2. The rotating electric machine system according to claim 1, wherein in the cooling medium supply path, a cross-sectional area of the inlet portion is 5 to 15 times a cross-sectional area of the opposite portion.

3. The rotating electric machine system according to claim 1, wherein the cooling medium supply path includes a first region and a second region between the inlet portion and the opposite portion in the circumferential direction, and
a rate of change in a cross-sectional area in the first region is larger than a rate of change in a cross-sectional area in the second region.

4. The rotating electric machine system according to claim 3, wherein the cooling medium supply path includes a middle portion located in a middle between the inlet portion and the opposite portion in the circumferential direction, and
the first region ranges from the inlet portion to the middle portion of the cooling medium supply path, and the second region ranges from the middle portion to the opposite portion of the cooling medium supply path.

5. The rotating electric machine system according to claim 1, wherein the plurality of cooling medium passages are arranged at equal intervals in the circumferential direction.

6. The rotating electric machine system according to claim 1, wherein the cooling medium discharge path has a constant cross-sectional area along the circumferential direction.

7. The rotating electric machine system according to claim 1, wherein in a cross section perpendicular to an axis of the rotating electric machine, an opening shape of each of the plurality of cooling medium passages includes an inner side portion constituting an inner side of the opening shape in a radial direction of the rotating electric machine, and
the inner side portion is parallel to a tangential direction of an outer circumferential surface of the stator.

8. The rotating electric machine system according to claim 7, wherein the opening shape includes an outer side portion that constitutes an outer side of the opening shape in the radial direction and is parallel to the inner side portion, and a pair of arc portions that connect the inner side portion and the outer side portion.

9. The rotating electric machine system according to claim 7, wherein the plurality of cooling medium passages are provided outside a central position in the radial direction of a circumferential wall portion of the rotating electric machine housing.

10. The rotating electric machine system according to claim 7, wherein the outer circumferential surface of the stator is fixed to an inner circumferential surface of the rotating electric machine housing.
